(19) United States
(12) Patent Application Publication
(10) Pub. No.: US 2011/0280770 A1
(43) Pub. Date: Nov. 17, 2011

(54) Nanogenerator

(76) Inventor: Jeffrey Lacy, Houston, TX (US)

(21) Appl. No.: 13/106,839

(22) Filed: May 12, 2011

Related U.S. Application Data
(60) Provisional application No. 61/334,015, filed on May 12, 2010.

(51) Int. Cl. G21C 1/00

(52) U.S. Cl. 422/159

(57) ABSTRACT

The present invention includes an improved ⁶²Zn/⁶²Cu generator for producing radiopharmaceuticals. The improvements comprising utilization of a significantly reduced generator column size and materials of construction that prevent contamination.

### CROSS-REFERENCE TO RELATED APPLICATIONS

Claims priority to provisional application 61/334,015.

### STATEMENTS REGARDING FEDERALLY SPONSORED RESEARCH OR DEVELOPMENT

Not applicable.

### REFERENCE TO A MICROFICHE APPENDIX

Not Applicable.

### BACKGROUND OF THE INVENTION

1. Field of the Invention

This invention relates to radiopharmaceuticals, and more particularly to an improved apparatus and method for producing carrier free, ionic ⁶²Cu.

2. Description of the Related Art

Positron Emission Tomography (PET) is an important and powerful diagnostic imaging tool; however, the distribution and regulatory issues associated with PET radiopharmaceuticals, such as ¹⁸F-FDG imply the need for generator-based imaging tracers. Proportional Technologies, Inc. (PTI) continues to refine the development of the ⁶²Zn/⁶²Cu generator that provides carrier free, ionic ⁶²Cu (t_{1/2}=9.7 min) and achieves instant high labeling yield with cGMP produced ligands in convenient lyophilized kit form. This system produces ⁶²Cu with unexcelled levels of purity and specific activity because of the intrinsic characteristics of its anion exchange medium having a strong affinity exclusively for Zn. The current generation of the ⁶²Zn/⁶²Cu generator (the “microgenerator”) and the lyophilized kits can be nationally distributed, satisfies regulatory requirements for human use, and the feasibility for both animal and human studies has been demonstrated. The ⁶²Cu half-life readily enables serial imaging studies, and the easy versatile coordination chemistry of copper provides wide ranging capabilities.

A rapidly emerging area for the diagnostic imaging is the development of new tumor-specific peptide-based radiopharmaceuticals. Since many peptide receptors are overexpressed on tumors, they make an attractive target for diagnostic imaging and radiotherapy with radiolabeled peptides. Producing these new radiopharmaceuticals successfully in the clinical setting requires in many instances very high specific activity (SPA) labeled peptide without any further HPLC purification.

Positron Emission Tomography (PET) is a unique imaging technique among the many diagnostic technologies available to clinicians. Unlike the majority of imaging techniques such as X-ray, SPECT, CT, ultrasound, MRI, or mammography that provide imaging of solid anatomical features, PET can measure functional characteristics of the tissue being imaged. As of 2004, approximately 900,000 PET scans were performed annually in the United States, and this number is predicted to grow to more than 2,000,000 by 2010. At a base cost of $3000-$6000 per PET scan, this represents a nearly $3 billion per year sector of the health care industry. PET is routinely used in combination with CT for monitoring treatment progress, and hybrid scanners capable of performing dual PET/CT scans during a single scanning operation are in common use. The vast majority of clinical studies currently employ the single metabolic tracer ¹⁸F-FDG.

Radioactive Copper Isotopes for PET Application: Copper offers simple coordination chemistry with a variety of ligands and has a group of promising positron-emitting radioisotopes, such as ^{60/61/62/64}Cu. The very short half-life of ⁶⁰Cu limits its use to a research setting with a dedicated cyclotron, although researchers at Washington University have successfully utilized this isotope in a clinical setting. The longer half-life of ⁶¹Cu potentially opens the door to distribution from regional radiopharmacies, but the lower abundance of the positron decay mode (only 60%) in ⁶¹Cu is problematic and the long half life of 3.41 hrs limits injectable dose and makes it impossible or at least very difficult to perform serial studies within a single clinic day. The much longer half-life of ⁶⁴Cu circumvents the processing and shipment problem, but low positron decay abundance together with severe injected dose constraints imposed by dosimetry make it very difficult to obtain PET images with reliable imaging statistics within reasonable image acquisition times. All of the cyclotron produced copper isotopes, relying upon enriched isotopic plating for each production are incredibly expensive for animal/preclinical studies. They are probably impractical for human studies because of the need for cyclotron operated under cGMP conditions at all clinical facilities. ⁶²Cu is the exception, which can be provided by an automated ⁶²Zn→⁶²Cu generator developed by Proportional Technologies, Inc. The 9.3 hour half-life of the ⁶²Zn parent is amenable to GMP assembly of the generator at a central production facility followed by express courier delivery to clinical sites. The wide distribution of this generator is feasible from a small number of production centers strategically located all over the country. The 9.3 hr half life of the ⁶²Zn parent is 5 times longer than the 110 minute ¹⁸F half life. That means the ⁶²Zn/⁶²Cu generator can be delivered over a radius that is 5 times greater. Thus a given center can serve 25 times the geographical area. Hence nearly 100 production facilities are required for ¹⁸F-FDG; only 4-8 centers are required for ⁶²Zn/⁶²Cu.

Success of the ⁶²Zn/⁶²Cu Microgenerator: PTI has developed an automated ⁶²Zn/⁶²Cu microgenerator that can work with three interchangeable lyophilized kits for instant synthesis of ⁶²Cu bis(thiosemicarbazone), or ⁶²Cu-BTS, radiopharmaceuticals.⁵⁻²⁵ This system is being nationally distributed and readily satisfies FDA requirements. The ⁶²Cu half-life of 9.7 min enables serial imaging studies and by allowing larger injected dose reduces patient imaging time. The ⁶²Zn/⁶²Cu microgenerator and associated BTS ligand kits have been used extensively by subcontracted clinical sites, interested third party academic and clinical researchers, and a major pharmaceutical company. PTI has successfully manufactured and delivered the microgenerator by overnight shipment with a private courier over 70 times. Table 1 summarizes the recipients of the microgenerator and the nature of the research conducted.

The ⁶²Zn/⁶²Cu microgenerator is compatible with high throughput use in a clinical setting. This system has high potential to become a robust source of PET ⁶²Cu agents with greater distribution capacity and lower cost than exists for currently available agents. As part of the generator development, PTI has also pioneered a facile, interchangeable kit-based synthesis of multiple ⁶²Cu-BTS radiopharmaceuticals. The BTS agents utilized by PTI display a range of human clinical profiles, and all are on firm regulatory footing with existing INDs or NDAs in place. Most recently, two large clinical studies have been funded for clinical application of agent ⁶²Cu-ETS at Indiana University/Purdue University at Indianapolis (IUPUI). These studies will focus on measurement of blood flow in head and neck and renal cancers and could solve the problem of providing a robust blood flow agent as a clinically practical alternative to ¹⁵O Water.

Since 1995, PTI has been actively engaged in the research and development of ⁶²Cu-BTS PET imaging agents. The first of these compounds, ⁶²Cu-Pyruvaldehyde bis(N4-methylthiosemicarbazone), or ⁶²Cu-PTSM, a perfusion agent, has had an active IND application filed with the FDA since 1995 and was followed with a NDA for the myocardial perfusion rest/stress imaging agent, trade name MyoPET, using the first generation ⁶²Zn/⁶²Cu generator system in 2001. The NDA was granted approvable status from the FDA in a letter in 2002. This NDA is eligible to be continued addressing concerns in the approvable letter.

Commercial IND's have been filed for the perfusion agent, ⁶²Cu-Ethylglyoxal bis(N4-methylthiosemicarbazone), also known as ⁶²Cu-ETS, in 2006 and for the hypoxia imaging agent, ⁶²Cu-Diacetyl bis(N4-methylthiosemicarbazone), also known as ⁶²Cu-ATSM in 2007. The second generation generator system, or the “microgenerator,” used to create instant kit synthesis of the aforementioned compounds was included with the ⁶²Cu-ETS IND; however, it works interchangeably with all three compounds.

TABLE 1
Summary of ⁶²Cu microgenerators manufactured by PTI

| # of Units | Type of Study | Ligand | Study Info | Recipient |
|---|---|---|---|---|
| 41 | Internal R&D | All | Generator/radiopharm | PTI |
| | | | development | |
| 23 | Animal | ATSM/PTSM | CNS pharmaceutrical | Merck |
| | | | development | |
| 15 | Animal | ATSM/PTSM | Rat/dog tumor hypoxia studies | M Dewhirst, D.V.M.-Duke Univ |
| 10 | Animal | ETS | Pig renal perfusion studies | L Willis, Ph.D.-IUPUI |
| 7 | Human | ATSM/PTSM | Human lung and head/neck | G Vlahovic, M.D.-Duke Univ |
| | | | cancer studies 10 Subjects | |
| 5 | Animal | ATSM/PTSM | Rapid injection studies | D Kadrmas, Ph.D.-Univ of Utah |
| 11 | Human | ETS/ATSM | Human Phase I 24 Subjects | C K Stone, M.D.-UW |
| | | | Phase II 13 Subjects | |
| 1 | Human | ETS | Human Phase II | J W Fletcher, M.D. and |
| | | | | M Green, Ph.D.-IUPUI |
| 1 | Animal | ATSM | Preliminary biodistribution rats | C K Stone, M.D.-UW |
| 1 | R & D | None | Radiopharm development | V Zavarzin-Naviscan PET Systems, Inc. |

In collaboration with the University of Wisconsin-Madison (UW), PTI has completed the Phase I and Phase II clinical study for ⁶²Cu-ETS. An additional Phase II study protocol has also been approved at IUPUI by the FDA, which involves the evaluation of tumor perfusion utilizing ⁶²Cu-ETS in head and neck cancer patients, employing ¹⁵O-water and ¹⁸F-FDG as comparators. A third Phase II study will soon begin at IUPUI after FDA approval is obtained to begin in renal cancer patients to measure tumor blood flow with ⁶²Cu-ETS.

A Phase I clinical study for ⁶²Cu-ATSM has also been complete by UW and the final report was submitted to the FDA in 2008. An animal feasibility study was completed by Duke University researchers comparing tumor hypoxia maps obtained from PET imaging using ⁶²Cu-ATSM and ⁶²Cu-PTSM autoradiographs and hypoxia maps generated through the use of an immunohistochemical marker in tumor-bearing rats. Table 2 summarizes the IND/NDA status for the various ⁶²Cu-BTS agents and indicates the number of human subjects who have received these agents.

TABLE 2
Regulatory status summary of PTI's ⁶² Cu-BTS compounds

| | | | | # of Human Subjects | |
|---|---|---|---|---|---|
| | | | | Administered with | |
| BTS Agent | IND #/NDA # | Filing Date | Status | BTS Agent | Target Population |
| ⁶²Cu-PTSM | 49462/21401 | Dec. 21, 1995 | Phases I-III Complete; | 132 | Normal; CAD patients; |
| | | (IND) | NDA granted | | cancer (lung, head/neck) |
| | | Aug. 31, 2001 | approvable status | | patients |
| | | (NDA) | | | |
| ⁶²Cu-ETS | 75018 | May 04, 2006 | Phase I complete; | 47 | Normal; CAD patients; |
| | | | Phase II studies | | Renal disease patients |
| | | | currently on-going | | |
| ⁶²Cu-ATSM | 76897 | Jan. 09, 2007 | Phase I complete | 31 | Normal; cancer (lung, |
| | | | | | head/neck) patients |

Peptide application in PET: Over the last two decades, small peptide-based radiopharmaceuticals targeting specific receptors for PET tumor imaging and targeted radiotherapy has been recognized and has attracted intensive investigation and development. This is attributable to the unique peptide receptors prolifically expressed in many tumor cells at higher levels than in normal tissues. The best examples are somatostatin (SST) analogs^{27,33-77} (targeting SST receptor overexpressed in neuroendocrine tumors(NETs)) TOC^{27,38-45} and NOC⁴⁶⁻⁵¹ peptide, RGD⁵²⁻⁷⁰ peptide analogs and multimers (targeting αᵥβ₃-integrin receptor highly expressed on neoangiogenic vessels in various cancers) and α-melanocyte-stimulating hormone (α-MSH) analog Re(Arg¹¹)CCMSH⁷¹⁻⁸² (targeting melanocortin-1 receptor in melanoma). These small peptides offer multiple advantages in imaging and therapy over proteins or antibodies. They can be easily synthesized and structurally manipulated to optimize their in vivo stability and improve their intrinsic high affinity to the corresponding peptide target receptor. They can be radiolabeled with isotopes such as ^{99m}Tc, ¹⁸⁸Re, ¹⁷⁷Lu, ²¹²Pb, ¹¹¹In, ⁸⁶Y, ⁶⁸Ga, ⁶⁴Cu ^{71,73,77} after coupling to bifunctional chelators (BFCs).⁸³ Because of their small size, they have much stronger ability to penetrate into tumors than large sized proteins or antibodies, they can reach peptide receptors on tumor cells efficiently, their localization and uptake into target cells and their clearance from the blood and non-target tissues is also very favorable. For example, the peak uptake time of ⁶⁴Cu-radiolabeled RGD dimer in female nude mice bearing U87MG tumor cells is only about 15 min and competing tissues are well cleared by this time.⁶⁷ Re(Arg¹¹)CCMSH reaches the highest uptake at 30 min in TXM-13JQ human melanoma-bearing Scid mice⁸⁴ and competing tissues are also well cleared. The promising TOC agent has been investigated in pilot patient studies in neuroendocrine tumours. Although the optimal imaging time was reported as 50 min in this study, the kinetic table provided showed almost no benefit to imaging after 20 minutes either in tumor uptake or background tissue clearance. With these fast tumor uptake and contrast times, short-lived ⁶²Cu, labeled peptides are physically and chemically feasible in the tumor imaging applications.

Bifunctional chelators are required to link the peptide to radionuclides. In selecting an appropriate BFC for coupling with a receptor peptide, two requirements are 1) that the binding of the radionuclide by the BFC be very rapid for instant labeling in the clinical setting and 2) that the BFC-metal chelate be very stable in vivo so that organs, such as the liver, do not develop high background levels of radioactivity during imaging studies. Among various chelators reported in the literature, macrocyclic tetraaza/triaza compounds NOTA (1,4,7-triazacyclononane-1,4,7-triacetic acid) satisfies these requirements for labeling and has been clearly demonstrated as highly superior in terms of instant labeling at room temperature to DOTA (1,4,7,10-tetraazacyclododecane-1,4,7,10-tetraacetic acid), the bifunctional chelators most frequently reported in the literature. The techniques for peptide bifunctionalization with such chelators are well known and widely practiced.

High specific activity formulations are required for PET imaging with peptides, especially if the peptide is able to induce pharmacologic effects, in even trace amounts. A perfect example is ReCCMSH(Arg11), a promising peptide agent that targets the melanocortin-1 receptor in melanoma imaging and therapy. All peptide agents have to go through preclinical screening studies using small animals like mice. The tumors in mice are very small in volume, typically just 1 gram or less, accordingly resulting in fewer available receptor sites. The melanocortin-1 receptor expresses only around 3000 active sites per cell. For a typical cell diameter of 20 microns, the number of tumor cells in a 1 mL tumor is approximately 2.4×10⁸. The number of ReCCMSH(Arg11) peptide molecules is 3.0×10¹¹ per nanogram, given a typical M.W. of 2000. Thus the amount of peptide that saturates the 1 mL tumor is at most 2.4 ng (2.4×10⁸×3000/3.01×10¹¹) or 1.2 pmol. In reality, the number of effective receptors may be far less than this number, because some of receptors on cells packed within a tumor are not accessible for binding. Therefore, to be assured of remaining below the saturation level the amount of peptide in the injectable dose ultimately should be significantly under 1.2 pmol or around 0.5 pmol corresponding to only 1 ng of 2000 MW peptide to be sure to avoid overwhelming the tumor receptors and degrading the tumor signal to background. With the injected peptide over this limit, only a fraction of the injected dose can go to the receptors in tumor and a huge amount may actually target other nonspecific organs/tissues that are actually weak receptors. Assuming that small animal PET imaging studies require ˜0.1 mCi ⁶²Cu injectable dose, the SPA for the labeled peptide must be higher than 83 Ci/μmol (0.1 mCi/1.2 pmol).

In the literature, the radiocopper (⁶⁴Cu) SPA for bifunctional ReCCMSH peptide derivatives was only <0.6 Ci/μmol⁷⁷ and the highest SPA reported was 19˜20 Ci/μmol labeled with the generator derived ⁶⁸Ga.⁷¹ Both of these SPA for the labeled peptides were obtained over lengthy reaction time at elevated temperature or with microwave-assisted procedure, together with very cumbersome HPLC purification post labeling. The requirement for HPLC purification of the radiolabeled material makes such studies very demanding, cumbersome, and expensive. with development of point of use automated synthesis and purification equipment. Such complex methodologies in turn create a massive headache for the regulatory process since in essence GMP must be practiced in preparing each dose at the point of use.

Through the application of BTS kits developed for human studies with the current microgenerator, high purity ⁶²Cu elution has demonstrated superior capability to achieve instant high labeling results in numerous human trials. If the same techniques can be transferred to the peptide application, the labeling of bifunctional peptides will be as simple as one minute mixing of the generator elution and a rehydrated lyophilized kit, the same as the application of the current microgenerator. This dramatically simplified methodology for the preparation of clinical injectable dose can also provide a rapid proven path for FDA approval for clinical use of the peptide. Clearly, an ultra pure copper isotope source would substantially benefit the investigation of the selection and efficacy evaluation of bifunctional peptides and in addition can provide the platform for rapid clinical translation of the diagnostic techniques. Our goal is to develop a new generation of ⁶²Cu generator that can provide ultra high pure ⁶²Cu²⁺ with unexcelled high specific activity, at least 10 times that of the current microgenerator that is limited to about 170 Ci/umol. The ultimate goal is to approach the theoretical SPA limit for the isotope (20,000 Ci/umol).

“Nanogenerator”: One superior feature for the generator derived ⁶²Cu in general is its unexcelled level of purity stemming from the chemical nature of the anion exchange column, the heart of the generator system. Kraus and his colleges have conducted thorough studies investigating the behavior of more than 60 metallic elements under different chloride concentration and their separation performance on anion exchange resin. Those with nuclear number smaller than 41 are 4 orders of magnitude more abundant than the lower Z metals, and therefore by far the highest possibility for contamination in ultra high purity solution. Among them, the only two metals can form chloride complexes at 2M concentration are Zn and Fe (III). Fe(III) chloride binds so weakly with the AG1X8 resin that it is completely absent after three column separation/purification steps during the ⁶²Zn purification process. These three steps use different sizes of anion exchange resin column to purify ⁶²Zn from the target dissolution solution at different manufacturing stages. Therefore Zn, the chemical form of the mother isotope of the ⁶²Cu generator, is the only metal that complexes strongly in 2M chloride eluant solution (1.8 M NaCl, 0.2 M HCl) utilized in the generator and is very strongly bound to the anion exchange resin column; and no other metal impurities (other than higher Z metals with natural abundance 4 orders of magnitude lower) can form anion complexes. Moreover, non-metallic materials are carefully selected for the construction of the entire generator fluid path, further limiting metal contamination. Inappropriate selection of generator materials can significant compromise the purity of the elution. One example is one type of commercial ⁶⁸Ge/⁶⁸Ga generator, based on a TiO₂ solid column. Elutions of this system often suffers large metal contamination such as Fe(III), Zn(II) and Al(III), in the range of 2100±1300 μg/L, 5050±147 μg/L and 1080±125 μg/L, respectively.⁸⁹ Fe and Al come from the metal column matrix whereas Zn is due to the accumulation of ⁶⁸Ga decay which is an intrinsic problem for all types of ⁶⁸Ge/⁶⁸Ga generator. Complicated post treatment of the Ga generator elution has become a must for any high specific activity peptide labeling and will surely be a big hurdle for FDA approval for any clinical application. The ⁶²Zn/⁶²Cu generator is largely immune to the problems discussed above and its major contamination source arises from trace metal levels in the chemicals (NaCl, water and HCl) formulating the eluant solution and to a lesser extent from metals washed from the materials in the fluid path. This can easily be mediated by treatment of all the chemicals with Chelex resin, a highly selective chelator for transition metal cations, and vigorous wash of the generator fluid path before the usage.

The ⁶²Cu SPA for the current microgenerator is typically 80-170 Ci per micromole of total copper. In comparison, the specific activity of ⁶⁴Cu from a typical supplier is only 2.6-12.8 Ci/μmol at the end of the cyclotron production, and is reduced by a factor of 4 to 0.65-3.2 Ci/μmol at a clinical site due to the decay during overnight transportation period. Thus the SPA of the current microgenerator is already 25-120 times compared to commercially available ⁶⁴Cu sources. However, typical small animal studies require ˜0.1 mCi of ⁶²Cu injection to obtain acceptable quality of PET imaging and given 10 min time for the labeling and injection preparation, requiring 1.2-2.5 pmol (or 2.4-5 ng of peptide, given a typical M.W. of ˜2000) be injected. Though the SPA of the current microgenerator is superior to any other systems, it falls far short of the optimal value (0.5 pmol). Clearly it is fundamentally important to develop an even higher specific activity generator that can provide ⁶²Cu with at least 10 times higher SPA for peptide investigation in the small animal and preclinical studies. We refer to this generator as a nano-generator because the ultimate goal is to produce doses with SPA high enough for the convenient, labeling of one nanogram (˜0.5 pmol) of peptide for preclinical investigation.

The proposed generator has an extremely miniaturized column, 10× smaller than the current generator that is eluted with nearly 10× smaller volume Producing a specific activity that is assured to be ˜10 times higher. Further improvement will be achieved by rigorous cleaning of all solutions with Chelex and by eliminating all materials from the fluid path that have the potential to bind metals. The current generator employs a glass eluant reservoir, a glass column and glass wool packing in the column, all sources of potential metal binding sites. The generator contains only a single eluant reservoir and a small column with a volume of 5 μL that is eluted by a modest pressurization in the sealed eluant reservoir, as shown in FIG. 1. The miniaturization of the column is possible because the mass of 200 mCi of ⁶²Zn (on the manufacturing day) is only about 30 ng, which represents a negligible 2.5% of the binding capacity of just 1 μL AG1X8 resin beads.

The background to the present invention and related art is best understood by reference to Applicant's own prior work. Applicant's issued patents and pending applications that may be relevant, including; (1) U.S. Pat. No. 5,573,747 entitled, “Method for Preparing a Physiological Isotonic Pet Radiopharmaceutical of ⁶²CU; (2) U.S. Pat. No. 6,264,597 entitled, “Intravascular Radiotherapy Employing a Safe Liquid Suspended Short-Lived Source”; and (3) U.S. patent application Ser. No. 10/571,202, entitled, “Miniaturized ⁶²Zn/⁶²CU Generator for High Concentration and Clinical Deliveries of ⁶²Cu Kit Formulation for the Facile Preparation of Radiolabeled Cu-bis(thiosemicarbazone) Compound.” Each of these listed patents are hereby incorporated by reference in their entirety for all purposes, including, but not limited to, supplying background and enabling those skilled in the art to understand, make and use in Applicant's present invention.

### BRIEF SUMMARY OF THE INVENTION

The present invention includes an improved ⁶²Zn/⁶²Cu generator for producing radiopharmaceuticals. The improvements comprising utilization of a significantly reduced generator column size and materials of construction that prevent contamination.

### BRIEF DESCRIPTION OF THE DRAWINGS

FIG. 1 is a depiction of an embodiment of the nanogenerator of the present invention.

### DETAILED DESCRIPTION OF THE INVENTION

To realize an important improvement in delivered specific activity and to lower cost of delivery in clinical applications, we present the “nanogenerator” with 10 fold reduced elution volume and substantially optimized materials of construction providing at least 10 times, and potentially 100 times, higher SPA. The proposed generator will be eluted in a small volume of 30 μL and combined with various bifunctionalized peptides or ligands via synthesis kits to produce an injectable dose instantly by simply mixing at room temperature. With polished design and better selected construction materials for the nanogenerator and an improved synthesis cell, the ultimate goal is to push the specific activity of the derived ⁶²Cu to levels approaching 19,400 Ci/μmol (the theoretical maximum), and that of the final radio-synthesized dose to 1000 Ci/μmol. Such a system will afford preparation of preclinical doses for mouse studies containing less than 1 ng of a typical peptide of MW 2000 (0.5 pmol). Reaching such levels is of profound importance because many peptide targets in small animals are expressed at only a few thousand receptors per cell or about 7×10¹¹ active sites per gram of tumor, dictating tumor saturation and compromised uptake at a level of less than 2.4 ng of injected peptide. The proposed miniaturization will also strongly aid the commercialization by lowing cost and complexity of distribution.

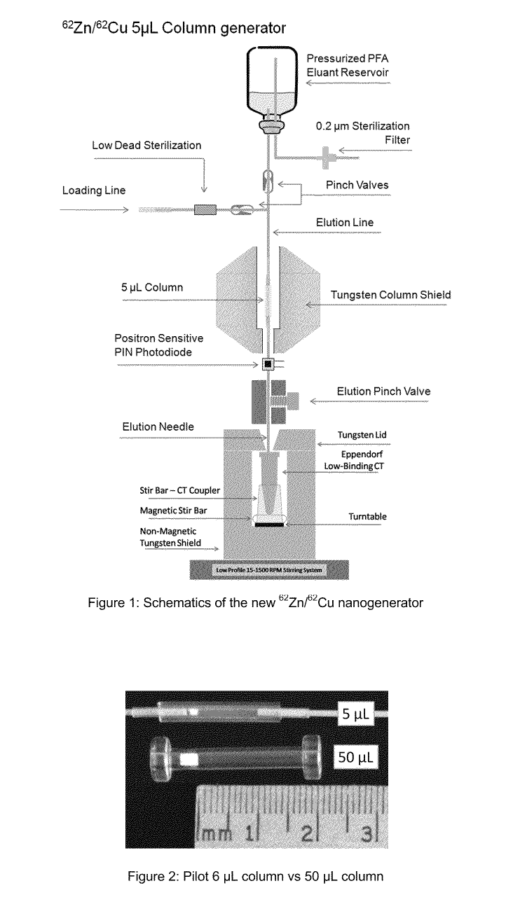

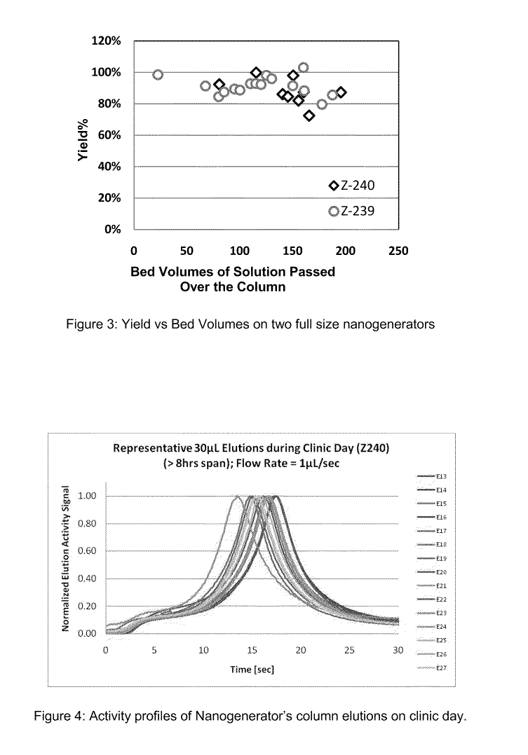

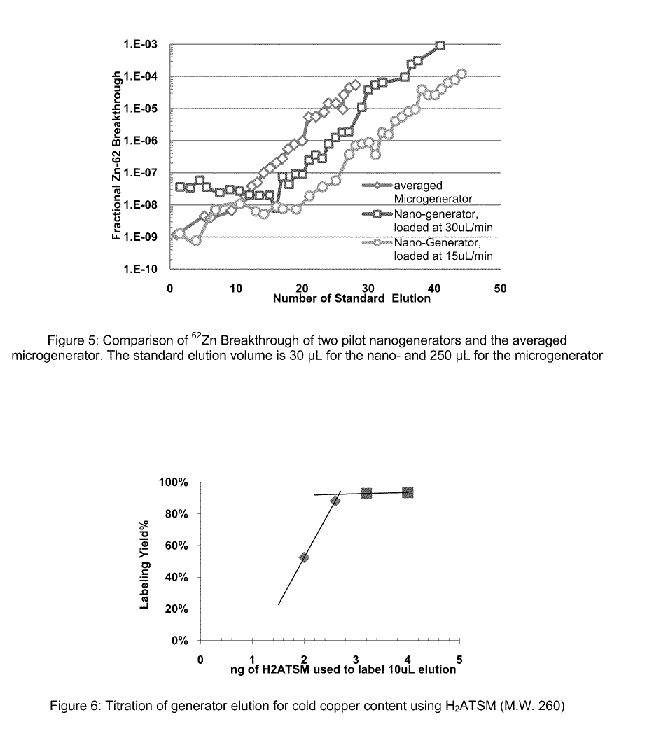

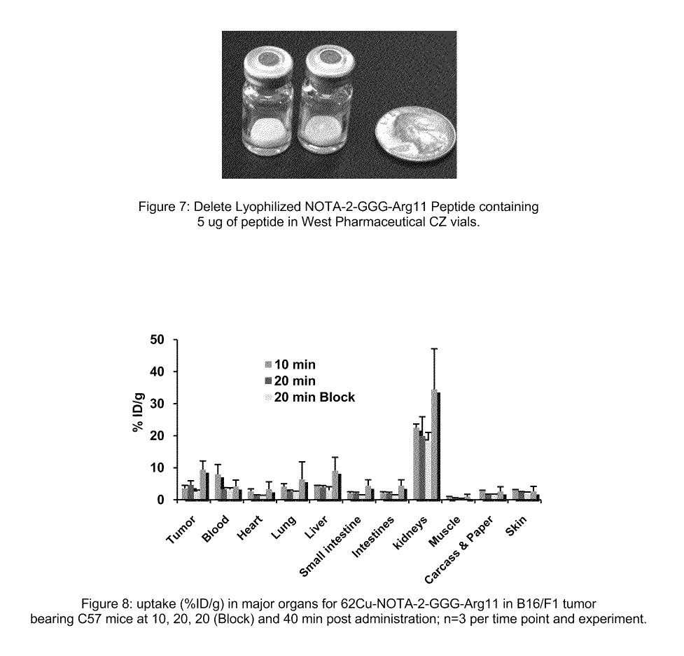

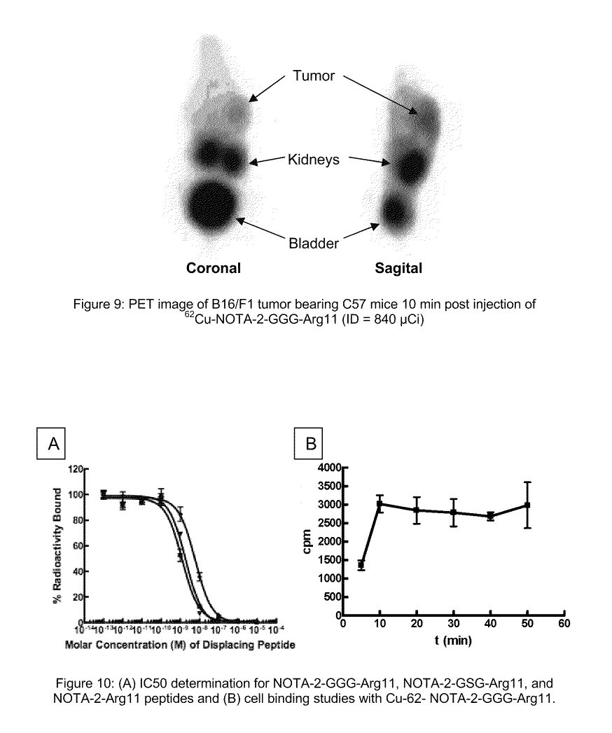

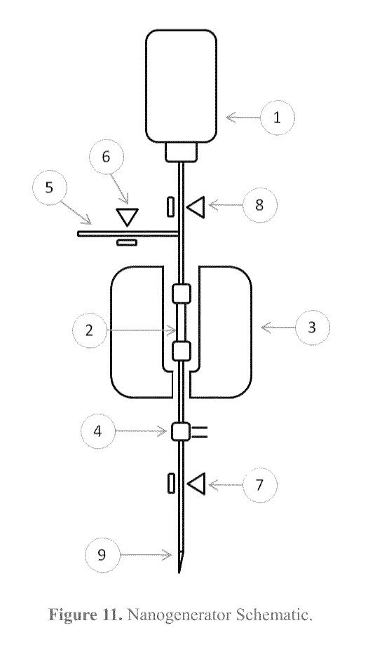

Construction of Nanogenerator: The construction of a pilot nanogenerator is shown in FIG. 1. Clear transparent PFA tubing (ID 0.040″, 0.8 cm for 6.3 μl volume) was selected as the column body to accommodate the anion resin AG1X8. A porous 30 μm polyethylene frit was installed to retain fine particles of the resin. The anion AG1X8 resin packed inside the PFA column uniformly with attentive observation. PEEK tubing (0.042″ OD and 0.005″ ID) was used for all liquid connections to column, and Pharmed tubing was used around the outside of the PFA column and PEEK tube connections to assure a leak free connection. To the end of the PEEK tubing from the bottom of column, a 2.3 cm Pharmed tube was attached providing the outflow path and to function in the illustrated pinch valve. A small PEEK tube with a beveled output end extended 3.6 cm from the Pharmed tube. Between the tungsten shield and the elution pinch valve, a positron sensitive PIN Photodiode sensor (3×3 mm²) was installed and connected through a low noise amplifier to a Labview system providing digitized elution profile traces for each elution. Eluant (1.8 M NaCl and 0.2N HCl) was contained in a sealed PFA bottle (40 mL), which was connected to the column input line using PEEK tubing. A short 1.5 cm small diameter PEEK tube (ID 0.070″) acted as flow-restrictor to ensure a consistent flow rate of 1 μL/min when the eluant reservoir was pressurized at 10 psi. The elution flow rate was held to 30±1.5 μl in a 30 sec elution period. During the pilot testing, it was found that the PFA vessel had a rather high permeability to helium or nitrogen requiring use of a pressurized source of gas during extended operation. The generator was loaded using a pressure system operated at 3.0±0.5 psi pressure giving a loading flow rate of 15±0.5 μl/min. Loaded activity was concentrated to a volume of 180 μL, giving a loading time of 12-15 min. The loaded column was flushed with the normal elution flow rate (30±1.5 μl in 30 sec) for 100 sec before beginning elutions.

Five prototype nanogenerators have been assembled using the above miniaturized column. To assess the potential radiation effects on the smaller resin bed, activities ranging from 9 mCi to 230 mCi were explored. For each generator, elution samples of 30- and 60-second duration were collected frequently over a period of two days. Sample activity levels were assayed in a dose calibrator (Capintec CRC-15) at the setting of 499 and decay corrected to obtain elution profiles and yield estimates. Following decay of ⁶²Cu (>4 hrs post elution), samples were counted in a germanium detector to measure ⁶²Zn breakthrough.

In summary, the dramatic change in the new design is to abandon glass or metal materials, to minimize the metal contamination. The vast reduction in column size (see FIG. 2), results in almost 10 time decrease in elution volume, thus almost 10 time increases in the activity per unit of volume. The system can be conveniently eluted over and over as frequently as every 30 minutes in the same manner as the current microgenerator.

⁶²Cu Yield: The five nanogenerators described above were tested over 2-3 days of simulated clinical/animal use in the pilot studies. These tests included two units loaded with <⅕ of the planned activity to explore the feasibility of design, and two full size units to validate the performance and safety of the system and one full size unit deployed to a remote collaborator's facility (University of Missouri) for actual animal PET scan and biodistribution study. All generators were loaded the afternoon before the first day of preclinical/animal use testing. Table 3 lists the averaged yield and breakthrough data on the day of the simulated preclinical use for the five microgenerators, as compared to a typical current clinical 50 μL bed volume microgenerator. Extensive in-house testing has been performed for the two full size generators, showing that the average yield (⁶²Cu eluted/⁶²Zn on column) produced in the first 30 seconds of elution were greater than current microgenerator yields and consistently approached the theoretical maximum yield of 90% for 30 minute inter-elution equilibration time. Furthermore, high yields were maintained under conditions of frequent elution throughout the two day testing period.

TABLE 3
Summary of the pilot nanogenerators' performance

| | | Avg % yield | ⁶²Zn breakthrough |
|---|---|---|---|
| | Load | with 30 min | fraction⁴ (Initial |
| | Activity | equilibration | levels on |
| Gen. ID | (mCl) | time | the loading day) |
| Current generator | 160-200 | 75 ± 10% | <1 × 10⁻⁷ |
| Z243b | 5.9 | N/A | <1 × 10⁻⁶ |
| Z238 | 41.7 | ~90% | <5.8 × 10^{-8 b} |
| Z239 | 236.9 | 90 ± 9% | <5.9 × 10⁻⁸ |
| Z240 | 219.4 | 88 ± 8% | <5.8 × 10⁻⁸ |
| Z242-animal study | 222.6 | 74% ^{c} | <4.3 × 10⁻⁸ |

a Normalized to a standard 30-uL elution
b Except the first elution, as 2 × 10⁻⁷
c Only one elution with 30 min equilibration time due to the timing arrangement for animal injections

FIG. 3 presented more detailed results for Z-239 and Z-240, which was fully loaded with 220-240 mCi of ⁶²Zn. The yields reported here were consistent among 80-100% for all elutions with 30 min equilibration time. Performance of the column was very stable over a large number of elutions. The 200 bed volumes of solution eluted in FIG. 3 is equivalent to forty 30 μL elutions and is far greater than the anticipated clinical use, which would typically not exceed one elution every 30 minutes (16 elutions/8 hour day).

On the simulated clinic day we eluted the R&D Nanogenerator (Z240) a total of 15 times, in an elapsed time of more than 8 hours. FIG. 4 shows the normalized activity profiles of all of these elutions.

⁶²Zn Breakthrough: The generator works under the assumption that the parent isotope is trapped on the selected column media and only the daughter isotope is flushed out in the elution. However, there is always certain level of parent isotope even in trace amounts leaching into the elution. The presence of the relatively long-lived isotope in the elution may cause contamination issue if its level is high. The breakthrough of ⁶²Zn is defined by the ⁶²Zn level measured in each elution over the amount loaded on the column at the time of measurement. FIG. 5 shows a comparison of the ⁶²Zn breakthrough for the averaged microgenerator and two pilot nanogenerators. As some other than standard 30-sec elutions were taken, all the breakthrough reported in the plot were normalized to a standard 30-sec or 30-μL elution for nano- and 250 μL for microgenerator. The plot demonstrates that both nanogenerators can restrict the breakthrough at extremely low level, even with significantly minimized resin bed size (10 times less compared to the current microgenerator). Actually most breakthrough of the nanogenerators were more than one order of magnitude lower compared to the same elution number of the microgenerator. When the purified ⁶²Zn was loaded on to the generators, the loading volume was identical (˜180 μL) but flow rates were different, 5 μL/min for micro- and 15 μL/min and 30 μL/min for the two pilot nanogenerators. Therefore the loading time required for the nanogenerator manufacturing is 3-6 times less, a substantial benefit in generator production. However, the pilot nanogenerator loaded at lower flow rate (15 μL/min) shows significant improvement for the breakthrough, around 5-10 times lower than the one loaded at the 30 μL/min, indicating that lower loading flow rate is a key factor contributing to the breakthrough level for the same column geometry. The results also show the nanogenerator breakthrough could be contained below the level of 1×10⁻⁵ for at least 35 standard elutions, more than the anticipated number of clinical/animal studies within the single day of use.

Rapid Cartridge Chromatography for the Assay of Labeling Yield: A rapid radiochemical labeling assay using cartridge chromatography has been developed and validated against HPLC.²¹ This assay uses the Oasis HLB cartridge from Waters. A well-trained clinical technician can follow simple instructions to complete the test in approximately one minute. Briefly an Oasis® cartridge is conditioned with 1 mL ethanol, followed by 2 mL of normal saline. An 1-100 μL aliquot of the labeled ligand solution is mixed with 900 μL of water or saline, loaded onto the conditioned cartridge and the cartridge is rinsed with 2 mL of normal saline into a 3 mL syringe. The syringe and the cartridge are assayed in a Capintec CRC-15R (setting=499) dose calibrator. The reported radiochemical purity is calculated as the radioactivity on the cartridge divided by the sum of the total radioactivity used in the assay (saline wash+residual radioactivity on the cartridge).

Specific ⁶²Cu Activity produced by the Nanogenerator: The ⁶²Cu specific activity for the nanogenerator has been evaluated by titrating ⅓ (10-μL) of one entire elution with small additions of H₂ATSM ligand and the labeling yield of the synthesized ⁶²Cu-ATSM was determined with cartridge chromatography. According to the labeling yield of the previous titration, the addition amount of ligand was changed for the next titration whereas the ligand concentration maintained at 0.1 μg/mL via appropriate dilution. This ligand concentration for titration is the concentration identical for the regular ⁶²Cu labeling using the current microgenerator and the 0.4 μg H₂ATSM lyophilized kit; and has been proven adequate with extensive testing. A typical titration curve is displayed below in FIG. 6, where the amount of ligand added is plotted on the X axis and the labeling yield on the Y-axis. This titration curve indicates that only 2.65 ng of H₂ATSM was required to overcome the cold copper or other competing metal levels and provide the excess needed to react quantitatively with ⅓ of the elution (max 60 mCi of ⁶²Cu²⁺ at typical clinical elution). Due to its short half life, ⁶²Cu does not contribute significant copper in this titration experiment so the full elution contained only 1.9 ng of cold copper. The typical clinic elution produces a 20-60 mCi dose indicating the specific activity of our typical clinical elution is up to max 31.5 Ci/μg or 2000 Ci/μmol. This level is about 1/10 the theoretical limit for ⁶²Cu which is 19,400 Ci/μmol. The same approach was used to measure the specific activity of the Cu-64 from the typical ⁶⁴Cu supplied by Washington University, St. Louis and we obtained values of 200 mCi/ug (or 12.8 Ci/micromole) and 41 mCi/μg (or 2.6 Ci/micromole) calibrated to end of cyclotron production on two successive evaluation shipments. Our results were consistent with the QC results from the manufacturer with less than 2% deviation. For comparison with ⁶²Cu values above, the decay in shipping (24 hrs) must be considered; therefore the ⁶⁴Cu specific activity drops by a factor of 4 to 0.65-3.2 Ci/μmol. Therefore ⁶²Cu derived from the nanogenerator including overnight shipping provides a quantum leap in specific activity compared to ⁶⁴Cu by a factor of 1953/3.2=610.

The ⁶²Cu specific activity of the current microgenerator has also been evaluated as 15 ng total copper per elution using the same titration approach. Given the typical clinic elution, dose as 20-40 mCi, the specific activity for the microgenerator is 1.3-2.7 Ci/μg. Thus the nanogenerator has increased the ⁶²Cu specific activity by 8-11 fold. Due to nature of the generator column producing the ⁶²Cu, the cold copper level generally doesn't correlate with the eluted activity dose, instead is related to the column size and the associated elution volume. With significant minimization of the generator column down to 5 μL from 50 μL, the generator elution volume decreased accordingly by a factor of 10 to 30 μL from 250 μL. Consistently, the cold copper level per each elution has been lowered approximately by a factor of 8 to 1.9 ng from 15 ng.

Pilot manufacture of NOTA functionalized peptide: To investigate the labeling performance of the nanogenerator, a pilot batch of NOTA-2-GGG-Arg11 peptide (provided by our collaborator, Dr. Thomas Quinn, University of Missouri) lyophilized kits (see FIG. 7) was manufactured in house using our recently installed lyophilization system. Low peptide binding West Pharmaceutical CZ vials were employed to minimize possibility of nonspecific binding of peptide to the glass surfaces. The pilot lyophilization cycle was performed as follows: Each vial was filled with 0.25±0.01 mL lyophilization solution containing 5 mg of sucrose excipient and 5 μg of peptide; then immediately frozen to −45° C. for 3 hr, followed by a vacuum cycle, followed by temperature ramp to room temperature. At the end of the vacuum cycle, the lyophilization chamber was backfilled with N₂ gas to −5 to −10 in/Hg, and then vials were sealed and placed under −70° C. for long term storage.

Labeling Yield and SPA for Peptide Labeling: In most of the pilot evaluation testing and animal study, the peptide labeling procedure was: A) one ligand vial was rehydrated with 100 μL water as a master solution; B) an aliquot (usually 10-μL) of this solution was mixed with the same volume of 2M NaOAc buffer in a low peptide binding centrifuge (CF) tube; C) 30-uL elution was taken from the nano-generator into the CF tube; D) the reaction solution was mixed vigorously for a few seconds and allowed to stand for one minute. The labeled dose required dilution with 450-μL water to reach isotonicity ready for animal/patient injection. Following labeling and dilution, the ⁶²Cu concentration was in the range of 2.5-10 mCi/0.1 mL. Due to the limitation of the max injectable dose, the prepared isotonic solution usually needed a second dilution with normal saline to reach desired dose concentration.

TABLE 4
Typical peptide labeling results using pilot nano-generators

| | | Volume of Labeling (μL) | | | Peptide | | Cu-62* | | Specific activity^{#} | |
|---|---|---|---|---|---|---|---|---|---|---|
| # | Sample | elution | buffer | peptide | ng | ng/μL | mCi | Yield % | mCi/μg | Ci/μmol |
| A | 3uL of E11, Z-239 | 3 | 1 | 2 | 100 | 16.7 | 6 | 97% | 58 | 116 |
| B | 3uL of E12, Z-239 | 3 | 1 | 2 | 100 | 16.7 | 5.2 | 98% | 51 | 102 |
| C | 3uL of E16, Z240 | 3 | 1 | 2 | 100 | 16.7 | 4.77 | 98% | 47 | 93 |
| D | 3uL of E18, Z240 | 3 | 1 | 1 | 50 | 10 | 3.85 | 95% | 73 | 146 |
| E | 3uL of E20, Z240 | 3 | 1 | 1 | 50 | 10 | 4.3 | 97% | 83 | 167 |
| F | entire E21, Z-239 | 30 | 10 | 5 | 250 | 5.6 | 34.0 | 87% | 118 | 237 |
| G | entire E20, Z-239 | 30 | 10 | 10 | 500 | 10.0 | 34.5 | 95% | 66 | 131 |
| H | entire E24, Z-240 | 30 | 10 | 10 | 500 | 10.0 | 26.8 | 94% | 50 | 101 |
| I | entire E19, Z-239 | 30 | 10 | 20 | 1000 | 16.7 | 35.8 | 97% | 35 | 69 |
| J | entire Eb, Z-242 | 30 | 10 | 10 | 500 | 10.0 | 35.1 | 92% | 65 | 129 |
| K | entire Ec, Z-242 | 30 | 10 | 10 | 500 | 10.0 | 30.5 | 95% | 58 | 116 |
| L | entire Ed, Z-242 | 30 | 10 | 10 | 500 | 10.0 | 28.7 | 94% | 54 | 108 |
| M | entire Ee, Z-242 | 30 | 10 | 10 | 500 | 10.0 | 27.8 | 96% | 53 | 107 |

*the activity of ⁶²Cuwas decay corrected to the time of elution
^{#}SPA = yield % × labeling activity (mCi)/peptide amount

Table 4 summarizes some typical results for the labeling using the three full size nanogenerators on the simulated clinic day. Instant high labeling yield was achieved within 2 min after the mixing of peptide and ⁶²Cu elution, as long as a sufficient amount of peptide was added and vigorous thorough mixing was provided. It has been observed that the properly vigorous mixing of the initial reaction solution in a small volume (˜50 μL) is the key for good labeling results. Tests A-E are labeling using only partial eluted activity (10%). They were conducted to test reaction parameters while lowering the personal exposure to radiation. The lowest peptide amount with good labeling yield was 50 ng, equivalent to 500 ng for an entire elution. Tests F-M are labeling using all the eluted activity. During the pilot investigation, an entire nanogenerator elution could be consistently labeled with high yield using 500 ng peptide with >95% yield but become relatively less reliable with 250 ng peptide. In the table, the highest SPA for the ⁶²Cu labeled peptide reached 237 Ci/umol (test J); however the labeling yield was relatively low (87%) with less peptide applied for the labeling. For those that achieved instant >95% high labeling yield, the highest SPA was 167 Ci/μmol (test E) using 10% of the total elution (4.3 mCi) and 131 Ci/mol (test G) using the entire elution (34 mCi). In comparison, the highest yield in literatures with ⁶⁸Ga was only ˜20 Ci/μmol, accomplished by cumbersome HPLC post purification after the labeling.⁷¹ It should be emphasized that the peptide dose size in the full elutions ranged from 27 mCi to 36 mCi compatible with very high statistics patient studies.

Pilot Animal Studies using ⁶²Cu labeled Peptide: Biodistribution and PET studies of radiolabeled ⁶²Cu-NOTA-2-GGG-Arg11 were performed in B16/F1 flank tumor bearing C57 mice utilizing the newly designed nanogenerator with the 5 μg lyophilized peptide kits. Fourteen male and female, 6-8 week old mice were injected with B16/F1 cells (1,000,000/mouse) in the flanks or shoulders while anesthetized to induce solid tumors. B16/F1 solid tumors appeared in 14 days post inoculation. Radiolabeled peptides were injected through the tail vein at an average of 0.27 mCi per dose administration for biodistribution studies and an average of 0.7 mCi for imaging, achieving specific activities of 111.2-140.4 Ci/μmol (mean=122.1 Ci/μmol), and an average of 94.0% radiolabeling yield without a purification step after synthesis. Animals in the biodistribution studies were sacrificed by cervical dislocation followed by pneumothorax at 10, 20, and 40 min post administration, major organs removed, weighed, and radioactivity quantitated in a windowed gamma counter. A competitive blocking experiment was performed at 20 min post administration, in which 20 μg of non-labeled NDP-MSH peptide was co-injected to demonstrate receptor specificity.

Uptake was measured for the tumor, blood, heart, lung, liver, small intestine, intestine, kidneys, muscle, carcass and paper, and skin. The biodistribution data is presented in FIG. 8. Tumor uptake was rapid, reaching 4.65±0.48 ID/g and 9.43±2.69% ID/g at 20 and 40 min post injection, respectively. Tumor uptake in the blocked mice was 0.55% of tumor uptake in the mice receiving the radiolabeled peptide alone at 20 min post injection demonstrating receptor specific uptake. The radiolabeled peptide exhibited clearance from the blood and non-target tissues except for the kidneys, which was the primary route of excretion.

A preliminary PET imaging study was also performed, in which two anesthetized animals were used for PET imaging studies starting at 10 min post administration of the radiolabeled peptide and statically imaged with a microPET-Focus scanner (Siemens Preclinical Solutions, Knoxville, Tenn.) for 20 min (see FIG. 9). The imaging study correlated well with the biodistribution data. The tumor is clearly visualized, with the majority of the radioactivity in the bladder and the kidneys. Background levels of radioactivity in the blood and major organs and tissues were low, except for the kidneys.

The biodistribution of ⁶²Cu-NOTA-2-GGG-Arg11 compared well to previously published studies using the melanoma targeting peptide conjugated with metal chelators DOTA or CBTE2A and radiolabeled with ⁶⁴Cu.^{77,80} Tumor uptake of DOTA and CBTE2A conjugated ⁶⁴Cu labeled peptides at 30 min post injection was 9.68±1.51% ID/g and 8.45±1.42% ID/g, respectively, compared to 9.43±2.69% ID/g for ⁶²Cu-NOTA-2-GGG-Arg11 at 40 min post injection. The result is even more impressive since the ⁶⁴Cu labeled peptides were HPLC purified prior to injection where as the ⁶²Cu labeled peptide was injected directly from the kit preparation without additional purification. The biodistribution pattern of ⁶²Cu-NOTA-2-GGG-Arg11 was similar to the ⁶⁴Cu labeled peptides, however the overall disappearance of radioactivity from the normal organs and tissues was slightly slower. This slight difference in clearance kinetic was attributed to the presence of the GGG spacer. The use of a more hydrophilic spacer or removal of the spacer would likely enhance the clearance of the ⁶²Cu NOTA conjugated peptide from the body, without affecting tumor uptake and retention.

Competitive binding studies were performed with NOTA-2-GGG-Arg11, NOTA-2-GSG-Arg11, and NOTA-2-Arg11 peptides to determine their IC50 values. Concentrations of the NOTA conjugated peptides ranging form 10-13 to 10-5 M were examined for their abilities to competitively displace the superpotent MSH analog ¹²⁵I-NDP from binding the melanocortin-1 receptor present on cultured B16/F1 cells. The IC50 values for NOTA-2-GGG-Arg11, NOTA-2-GSG-Arg11, and NOTA-2-Arg11 peptides were 1.97×10⁻⁹, 5.99×10⁻⁹ and 1.25×10⁻⁹, respectively (FIG. 3A). These resulted demonstrated that all three peptides had high affinity and specificity for the melanocortin-1 receptor. In fact NOTA-2-GGG-Arg11 and NOTA-Arg11 peptides had superior IC50 values compared to the CBTE2A-ReCCMSH peptide(IC50=5.4×10⁻⁹), which was the optimal peptide construct for Cu-64. The NOTA-2-GGG-Arg11 was selected for in vitro cell binding studies based on the IC50 studies and that it contained a spacer sequence between the NOTA and the receptor targeting peptide. It was postulated that spacing the NOTA chelator away from the peptide would prevent steric hinderance of the chelator and improve labeling.

In vitro cell binding studies were performed with ⁶²Cu-NOTA-2-GGG-Arg11 to demonstrate tumor cell targeting. Tissue culture wells containing 1 million cells each were incubated with 320,000 cpm of ⁶²Cu-NOTA-2-GGG-Arg11 for various times between 5 min and 50 min then washed and counted. The melanoma cells demonstrated rapid uptake of the radiolabeled peptide that reached a maximum of 10% at 10 min post application and remained constant for 50 min (see FIG. 10). The cell binding results demonstrated that the specific activity of the ⁶²Cu-NOTA-2-GGG-Arg11 preparation was high enough for effective melanoma tumor cell targeting. In vitro cell binding of 10% for the ⁶²Cu-NOTA-2-GGG-Arg11 peptide is similar to then in vitro cell uptake percentages for HPLC purified. The in vitro cell binding assay is very sensitive to the specific activity of the radiolabel peptide do to the limited numbers of receptors present per well. ⁶²Cu-NOTA-2-GGG-Arg11 is the first non-HPLC purified radiolabeled peptide preparation that demonstrated any cell binding in vitro much less a percentage cellular uptake that was equal to HPLC purified peptides. These results demonstrate that the specific activity of ⁶²Cu-NOTA-2-GGG-Arg11 obtained directly from the kit preparation is high enough for effective melanoma tumor targeting.

TABLE 5
Comparison of the two generations of ⁶²Zn/⁶²Cu generators

| | Nano | Micro |
|---|---|---|
| Generation | generator | generator |
| Column Bed Volume (μl) | 6 | 50 |
| Max Loaded Activity for ⁶²Zn* (mCi) | 60 | 50 |
| Max Eluted Activity for ⁶²Cu* (mCi) | 60 | 40 |
| Elution Volume (uL) | 30 | 250 |
| Max Eluted Activity/Volume* (mCi/μL) | 2 | 0.16 |
| Final Isotonic Injectable Volume^{#} (mL) | 0.5 | 4.0 |
| Max Injectable Dose per 0.1 mL⁺ (mCi) | 12 | 1.0 |
| Max ⁶²Cu Specific Activity (Ci/μmol total Cu) | 2000 | 169 |

*The typical activity eluted at 8 am at clinical site.
^{#}Less injection volume leads to less injectable dose.
⁺Common max injectable volume for small animals like mice.

Summary of Nanogenerator performance: In summary, the results of pilot studies showed that a dramatically miniaturized column can actually perform significantly better than the current microgenerator with respect to important parameters, including yield and breakthrough, and that such performance can be maintained over the course of expected clinical use. Pilot study results also showed that pressure-driven elution was highly reproducible and that anticipated variability in delivered volume was within acceptable limits. The final pilot generator demonstrated that the system could be shipped overnight to a remote facility and produced clinically acceptable doses (>20 mCi) of ⁶²Cu throughout the day of use flawlessly producing elutions for animal studies. These findings strongly support the feasibility of the proposed nanogenerator design.

### Apparatus

The schematic of the ⁶²Zn/⁶²Cu nanogenerator manufactured for pilot studies is also shown in FIG. 11 and its parts described in Table 11. Plastic materials and high purity reagents were used to avoid trace metal contamination. PTI previous generators are constructed from glass; however, glass is well known to be a source of heavy metals. The alternative is to use plastic, such as PEEK, PFA, PS, for the nanogenerator. Contamination from chemicals will be eliminated by employing ultra-high purity chemicals and treating with Chelex-resin.

The column was significantly reduced, from 50 uL to 5 uL (with respect to previous generation), which will result in less contamination since the same dose is eluted in 10× less volume. The surface area is reduced by a factor of 4, resulting in less exposure to possible impurities, if any, that may leech from the generator components. These features are incorporated into the design of a third generation ⁶²Zn/⁶²Cu generator which provides a source of ultra pure ⁶²Cu²⁺ with high specific activity >2,000 Ci/umol approaching the theoretical SPA limit of ⁶²Cu, 19,400 Ci/umol. We refer to this generator as a nano-generator because the ultimate goal is to produce doses with SPA high enough for the convenient, labeling of one nanogram (˜0.5 pmol) of compound for preclinical investigation.

TABLE 11
Nanogenerator Parts Description

| Label # | Description |
|---|---|
| 1 | Pressurized Eluant (1.8M NaCl and 0.2N HCl) contained in a |
| | sealed PFA bottle (40 mL), which is connected to the column input |
| | line using PEEK tubing. |
| 2 | Anion exchange generator column; Volume = 5 uL; Materials: |
| | Polystyrene (radiation resistance 8 × 10⁹ rads) column and |
| | C-flex tubing connections. |
| 3 | Tungsten shield, capable of safely shield (and safely ship) |
| | columns loaded with 50 mCi ⁶²Zn at clinic day. |
| 4 | PIN Photodiode sensitive for positron emissions. Used for real |
| | time monitoring of the column elutions. |
| 5 | ⁶²Zn loading line for generator column. |
| 6 | In-line pinch valve (over C-Flex tubing) to control flow course. |
| 7 | In-line pinch valve (over C-Flex tubing) to control elution outflow. |
| 8 | In-line pinch valve (over C-Flex tubing) to control loading |
| | flow course. |
| 9 | Output of eluted ⁶²Cu from column. The elution volume is 30 μL |
| | at a flow rate of 1 μL/min. |

The overall production and utilization of the Nanogenerator is a simple and straightforward process. The anion exchange column is loaded with parent isotope ⁶²Zn to a desired level relative to the time of its clinic use. After passing the standard quality control tests, the generator is packaged, labeled and released to the clinic site. At the clinical setting, the nanogenerator is received and ready to be used for multiple elutions. The ⁶²Zn/⁶²Cu nanogenerator has a exceptional labeling flexibility; we have previously shown that the it can work with three interchangeable lyophilized kits for instant synthesis of ⁶²Cu bis(thiosemicarbazone), or ⁶²Cu-BTS, radiopharmaceuticals¹⁻²⁰ as well as other peptides²¹. A rapid radiochemical labeling assay using cartridge chromatography has been developed and successfully validated against HPLC.¹⁷

In summary, results from our pilot studies have shown that a dramatically miniaturized column can actually perform significantly better than the previous generation of the ⁶²Zn/⁶²Cu generator with respect to important parameters, including yield and breakthrough, and that such performance can be maintained over the course of expected clinical use. Pilot study results also showed that pressure-driven elution was highly reproducible and that anticipated variability in delivered volume was within acceptable limits. The final pilot generator demonstrated that the system could be shipped overnight to a remote facility and produced clinically acceptable doses (>20 mCi) of ⁶²Cu throughout the day of use flawlessly producing elutions for animal studies and potentially for human use.

### Innovation

This device seeks to undertake the final innovative steps in bringing ⁶²Cu to clinical reality as a practical low cost PET tracer, coupling with methods of synthesis that can be accomplished in the clinicians' hands using instant kit technology afforded by metal chelation chemistry, which eliminates the cost of setting up and operating hundreds of GMP facilities that took over a decade to complete for ¹⁸F-FDG. This high cost, complex, and time intensive process is the reason of the stagnant PET field. Our approach is to utilize an almost trivial, simple inorganic system to deliver purified ⁶²Zn and load this parent agent on generators, an incredibly straightforward process compared to organic synthesis processes required for ¹⁸F agents, and approximately 25 times fewer processing facilities are required. The miniaturization proposed here is very important to this distribution process since weight and size of the delivered generator will be substantially reduced and loading systems can be far more compact. The final innovation and the focal one is the development of a means of delivery of a radiopharmaceutical at an absolute world record level of specific activity allowing targeting cell signaling at levels not dreamed of with any other method. This technology will provide this capability not as a narrow research dream but rather can truly make a broad spectrum of PET agents available that will move rapidly through the regulatory process and finally facilitate getting the powerful PET technique to the patient! We have shown in previous studies and ongoing FDA process that very effective perfusion agents can be produced that could eventually carry the brunt of the diagnostic load in myocardial perfusion imaging. It is very important to realize that the innovation of this proposal is not in the details of making a column smaller, or using the right materials to avoid metal contamination, but it is about putting all of these things together and producing a technology that can serve as the base for shoring up a very valuable field of diagnostic imaging that is currently foundering.

### REFERENCES

1. Lacy, J. L., Chien, S. C., Lim, J. K., Mathias, C. J. & Green, M. A. Modular Automated Zn-62/Cu-62 PET Radiopharmaceutical Generator. Journal of Nuclear Medicine 36, 49P (1995).
2. Lacy, J., Rau, V., John, E. & Green, M. A. Cu-62-PTSM and related bis(thiosemicarbazone) complexes produced by an automated Zn-62/Cu-62 generator for myocardial PET perfusion imaging. J Nucl Med 37, 308P (1996).
3. Wallhaus, T. R., et al. Human biodistribution and dosimetry of the PET perfusion agent copper-62-PTSM. J Nucl Med 39, 1958-1964 (1998).
4. Lacy, J. L., et al. Performance of a Zn62/Cu62 generator in clinical trials of the PET perfusion agent Cu-62-PTSM. J Nucl Med 39, 142P (1998).
5. Lacy, J. L., Haynes, N. G. & Nayak, N. Evaluation of the new generator-produced PET radiopharmaceutical Cu-62 ETS versus Cu-62-PTSM for myocardial perfusion imaging. Journal of Nuclear Medicine 40, 171 (1999).
6. Lacy, J. L., et al. PET Myocardial Perfusion Imaging with Generator Produced Radiopharmaceuticals. 62Cu-PTSM and 62Cu-ETS. Clin Positron Imaging 2, 317 (1999).
7. Lacy, J. L., Nayak, N., Mathias, C. J. & Green, M. A. PET myocardial perfusion imaging with Cu-62 bis(thiosemicarbazone) agents. Journal of Nuclear Cardiology 6, S11 (1999).

8. Haynes, N. G., et al. Performance of a 62Zn/62Cu generator in clinical trials of PET perfusion agent 62Cu-PTSM. J Nucl Med 41, 309-314 (2000).
9. Wallhaus, T. R., Lacy, J. L., Nayak, N., Nickles, R. J. & Stone, C. K. A comparison of myocardial PET imaging with 62Cu-PTSM and the novel PET tracer 62Cu-ethylglyoxal bis(thiosemicarbazone)(62Cu-ETS) in humans. Journal of Nuclear Cardiology 7, S7 (2000).
10. Wallhaus, T. R., et al. Copper-62-pyruvaldehyde bis(N-methyl-thiosemicarbazone) PET imaging in the detection of coronary artery disease in humans. J Nucl Cardiol 8, 67-74 (2001).
11. Lacy, J. L. Miniaturized ⁶²Zn/⁶²Cu Generator for High Concentration Clinical Delivery of ⁶²Cu Kit Formulation for the Facile Preparation of Radiolabeled Cu-bis(thiosemicarbazone) Compounds. (ed. Proportional Technologies, I.) (United States, 2004).
12. Green, M. A., Mathias, C. J., Hutchins, G. D., Willis, L. R. & Lacy, J. L. Performance of a Micro Cu-62 Generator System in the Synthesis and Delivery of Kit-Formulated ⁶²Cu-ETS for PET Perfusion Imaging. Journal of Nuclear Medicine 47, 525P (2006).
13. Green, M. A., et al. Evaluation of ⁶²Cu-ETS as a PET tracer of renal perfusion in a porcine model of acute focal renal injury. Journal of Nuclear Medicine 47, 146P (2006).
14. Green, M. A., et al. Assessment of Cu-ETS as a PET radiopharmaceutical for evaluation of regional renal perfusion. Nucl Med Biol 34, 247-255 (2007).
15. Stephens, A., et al. Automation and improved performance of a ⁶²Zn/⁶²Cu microgenerator system. Journal of Nuclear Medicine 49, 95P (2008).
16. Yue, Z., Stephens, A., Bui, H., Thrash, T. & Lacy, J. L. QC Performance of a ⁶²Zn/⁶²Cu microgenerator system for use in PET imaging. Journal of Nuclear Medicine 49, 95P (2008).

17. Thrash, T., Yue, Z., Stephens, A., Bui, H. & Lacy, J. L. QC evaluation of ⁶²Cu bis(thiosemicarbazone) instant synthesis kits for PET imaging. Journal of Nuclear Medicine 49, 309P (2008).
18. Lacy, J. L., et al. Generator/kit produced ⁶²Cu-ETS, a PET perfusion agent with minimized plasma binding. Journal of Nuclear Medicine 49, 284P (2008).
19. Wong, T. Z., et al. PET of hypoxia and perfusion with 62Cu-ATSM and 62Cu-PTSM using a 62Zn/62Cu generator. AJR Am J Roentgenol 190, 427-432 (2008).
20. Lacy, J., et al. Phase II renal imaging studies with the new high flow perfusion agent Cu-62 ETS. in Society of Nuclear Medicine Annual Meeting 2009 (Toronto, Canada, 2009).
21. Yue, Z., et al. Instant Cu-62 labeling of the NOTA functionalized melanoma targeting peptide NOTA-ReCCMSH(Arg11). in Society of Nuclear Medicine Annual Meeting 2009 (Toronto, Canada, 2009).

We claim:

1. An apparatus useful for production of a radiopharmaceutical comprising:
an eluant vessel and a valve for facilitating release of an eluant from such vessel;
an anion exchange generator column having a volume less than about 10 ul;
said column having a second valve for selectively receiving a flow of a radioactive isotope in solution into said column and a third valve for controlling flow of an eluant from said vessel into and through said column to a dispersing outlet point; and
an output for removing eluted ⁶²Cu from said column.

2. An apparatus of claim 1 wherein the dispensing outlet point is a needle tip.

3. An apparatus of claim 1 wherein the radioactive isotope is ⁶²Zn.

4. An apparatus of claim 3 wherein for each production of a radiopharmaceutical the column is eluted with 10 to 30 uL of eluant.

5. An apparatus of claim 1 further comprising a PIN photodiode sensitive for positron emissions used to monitor in real time column elutions.

6. An apparatus of claim 1 wherein said eluant vessel further comprises means for controlling pressurization of said eluant vessel.

7. An apparatus of claim 1 wherein for each production of a radiopharmaceutical 10 to 30 uL of eluant is released through the column at a flow rate of 30 uL/min or faster.

8. An apparatus of claim 1 wherein said column is made of Polystrene.

9. An apparatus of claim 1 further comprising a tungsten shield around said column.

10. An apparatus of claim 1 further comprising ⁶²Zn loading line for said column.

11. An apparatus of claim 1 further comprising C-Flex tubing connections to control eluant flow course.

12. An apparatus of claim 1 wherein said vessel is a sealed PFA bottle.

13. An apparatus of claim 12 wherein said vessel is connected to said column through PEEK tubing.

14. An apparatus of claim 1 wherein the eluant vessel is pressurizable and allows for controlled release of an eluant from said vessel.

15. An apparatus of claim 1 further comprising C-Flex tubing connections to control elution outflow.

16. A system useful for production of a radiopharmaceutical comprising:
a pressurizable eluant vessel and means for controlling release of an eluant from such vessel;
an anion exchange generator column having a volume less than about 10 ul;
said column having means for selectively receiving a flow of a radioactive isotope in solution into said column and means for controlling flow of an eluant from said vessel into and through said column to a dispersing outlet point; and
an output for removing eluted ⁶²Cu from said column.

17. The system of claim 16 wherein the dispensing outlet point is a needle tip.

18. The system of claim 16 wherein the radioactive isotope is ⁶²Zn.

19. The system of claim 18 wherein for each production of a radiopharmaceutical the column is eluted with 10 to 30 uL of eluant.

20. The system of claim 16 further comprising a PIN photodiode sensitive for positron emissions used to monitor in real time column elutions.

21. The system of claim 16 wherein said eluant vessel further comprises means for controlling pressurization of said eluant vessel.

22. The system of claim 16 wherein for each production of a radiopharmaceutical 10 to 30 uL of eluant is released through the column at a flow rate of 30 uL/min or faster.

23. The system of claim 16 wherein said column is made of Polystrene.

24. The system of claim 16 further comprising a tungsten shield around said column.

25. The system of claim 16 further comprising ⁶²Zn loading line for said column.

26. The system of claim 16 further comprising C-Flex tubing connections to control eluant flow course or control elution outflow.

27. The system of claim 16 wherein said vessel is a sealed PFA bottle.

28. The system of claim 27 wherein said vessel is connected to said column through PEEK tubing.

29. An apparatus useful for production of a radiopharmaceutical comprising:
an eluant vessel and a valve for facilitating release of an eluant from such vessel;
an anion exchange generator column having a volume less than about 10 ul;
a PIN photodiode sensitive for positron emissions used to monitor in real time column elutions;
ligand reservoir(s) preloaded with ligand solution of choice for isotope labeling;
a mixing channel that combines eluted isotope with preferred ligand solution;
electrically actuated valves for driving flow and flow control;
said generator column, PIN photodiode, ligand reservoir(s), mixing channels and flow control valves placed on a microchip; and
an output for removing eluted Cu-62 from said column.
